(19) United States
(12) Patent Application Publication
(10) Pub. No.: US 2004/0103107 A1
(43) Pub. Date: May 27, 2004

(54) Method for increasing the sorting capacity for the sortation of flat items

(75) Inventors: Raymond P. Brady, Pullach (DE); Peter Bretschneider, Birkenwerder (DE); Jean-Claude Oppliger, Niederhasli (CH)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS SCHWEIZ AG, ZURICH (CH)

(21) Appl. No.: 10/713,202

(22) Filed: Nov. 17, 2003

Related U.S. Application Data
(63) Continuation of application No. PCT/EP02/02932, filed on Mar. 16, 2002.

(30) Foreign Application Priority Data
May 18, 2001 (EP) 01 112 228.0

(51) Int. Cl. G06F 17/00

(52) U.S. Cl. 707/100

(57) ABSTRACT

The present invention relates to a method for sorting items which are provided with delivery information. The method includes the use of a continuous sorting conveyor having a given determining path and a plurality of determining path elements. The elements are respectively divided into a number of determining sections. The determining sections have a plurality of consecutive determining positions.

### CONTINUATION DATA

The present invention is a continuation of international application number PCT/EP02/02932, filed on Mar. 16, 2002 and which designated the United States, and further claims priority to priority document EP01112228.0, filed on May 18, 2001, the both of which are herein incorporated by reference.

### BACKGROUND OF THE INVENTION

The invention relates to a method for the sorting delivery-information-bearing items using a continuous sorting conveyor. The delivery information may be a destination or mailing address and the items may be post. The sorting is made according to a specified destination route with a number of destination route sections each subdivided into a number of destination sub-sections, the destination sub-sections having a number of consecutive destination positions.

Unexamined German application DE 197 14 184 A1 teaches that in order to sort items according to a specifiable destination route, e.g. in mail carrier delivery sequence order, sorting strategies are used whereby, instead of a mailing address being assigned to each sorting compartment, the sequence of the mail items within the sorting compartments is part of the sorting result. For this purpose, a plurality of sorting passes on a sorting conveyor is generally required.

The sortation items are transferred from a single feeding station to receiving elements which are moved along a continuous conveying route. Along the conveying route there are successively disposed sorting compartments. The compartments may be used for two sorting cycles. The cycles may correspond to a sorting according to a destination route. The information record provided on the individual items, whose meaning and content correspond to an address (destination position) are detected. The item is selectively discharged from its receiving element, to the sorting compartment appropriately provided for the detected information record. The receiving element is returned empty to the feeding station after the item has been discharged. The capacity of the sorting facility is not therefore fully utilized. The capacity of the sorting facility can only be increased by making the device larger, by reducing the width of the receiving elements, or by increasing the speed of the continuous conveying device. There are limits to how much the speed of the continuous conveying device can be increased and to how much the width of the receiving elements can be reduced.

### SUMMARY OF THE INVENTION

An object of the present invention is to provide a method whereby the sorting capacity may be increased. This and other objects are achieved according to the invention using a method wherein:

a) the sortation items are fed to the continuous sorting conveyor using at least two feeding stations corresponding to no more than the number of destination route sections, with a number of sorting compartments being disposed between two feeding stations;

b) in a first sorting cycle, the sortation items are conveyed according to their relevant destination position to a corresponding sorting compartment, the number of consecutive sorting compartments corresponding to the largest number of destination positions located within one of the destination sub-sections, and

c) in a second sorting cycle, the items thus conveyed to the sorting compartments are fed back into the sorting conveyor by the feeding stations in destination position sequence and conveyed, according to their relevant destination sub-section, to a sorting compartment corresponding to the destination sub-section, the number of sorting compartments corresponding to the number of destination sub-sections.

The following advantages can be achieved using the abovementioned method:

i) Increasing the sorting capacity without increasing the speed of the continuous sorting conveyor and without reducing the width of the receiving elements;

ii) Increasing the sorting capacity with the size of the facility remaining unchanged, which means that the space requirement for the sorting conveyor remains the same and involves less capital investment compared to procuring an additional facility; and

iii) No increase in the number of sorting compartments is necessary.

### BRIEF DESCRIPTION OF THE SEVERAL VIEWS OF THE DRAWINGS

The invention will now be explained in greater detail with reference to the accompanying drawings, wherein:

FIG. 1 schematically illustrates a sortation with two sorting cycles;

FIG. 2 schematically illustrates a first continuous sorting conveyor whose destination route is divided into two destination route sections;

FIG. 3 schematically illustrates a continuous sorting conveyor whose destination route is divided into two destination route sections and wherein the sortation items for the first destination route section are fed in from a first feeding station and the sortation items for the second destination route section are fed in from a second feeding station;

FIG. 4a shows a first sorting cycle of the continuous sorting conveyor according to FIG. 2 with two feeding stations, and

FIG. 4b shows a second sorting cycle of the continuous sorting conveyor according to FIG. 3 with two feeding stations.

### DETAILED DESCRIPTION OF THE INVENTION

The method according to the invention will now be described using the example of a sorting conveyor for flat delivery-information-beating sortation items 2 wherein the sortation items 2 are sorted according to a specifiable destination route W in two sorting cycles.

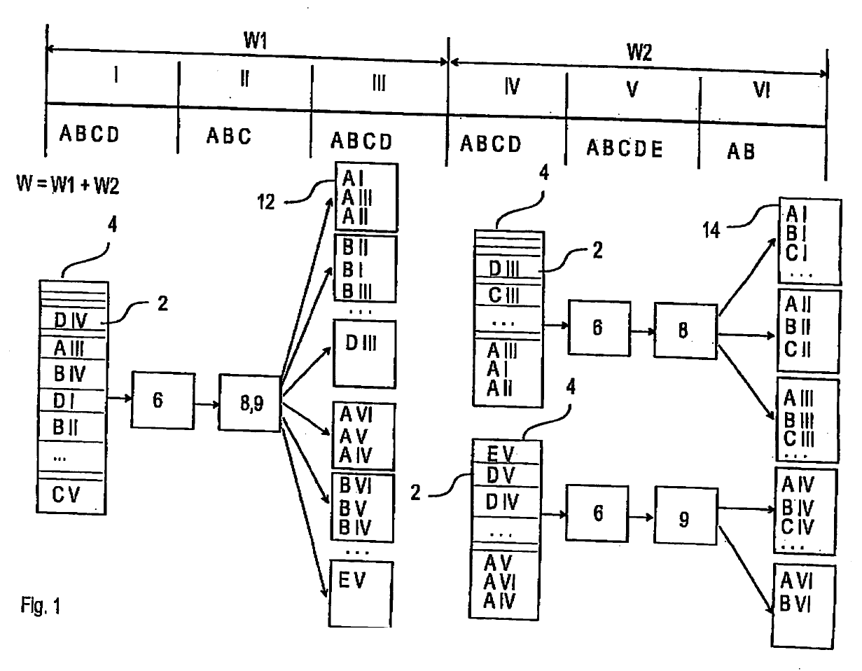

FIG. 1 schematically illustrates a sorting method with two sorting cycles. A delivery route designated as destination route W is subdivided into a number of destination route sections W1 and W2. The destination route sections W1 and W2 are in turn divided into destination sub-sections I, II, III, IV, V, and VI. Each destination sub-section I, II, III, IV, V, and VI has a number of consecutive destination positions A to E which correspond to delivery addresses on the sortation items 2. A sortation item 2 is not necessarily present during each sortation for each destination position A to E of the relevant destination sub-section I, II, III, IV, V, and VI. In the sortation shown in FIG. 1, only the destination positions A to E of the relevant destination sub-section I, II, III, IV, V, VI for which sortation items 2 are present are shown. Accordingly, not all the sub-sections include all destination positions A to E.

A number of sortation items 2 which are to be sorted according to the destination route W sequence are transferred from a sortation stack 4 via reading device 6 and feeding stations 8, 9, to continuous sorting conveyor 16 (not shown in FIG. 1). The reading device 6 is used to read and otherwise detect the destination address on the sortation item. Depending on the delivery information detected, the sortation items 2 are selectively discharged from the continuous sorting conveyor 16 to one of the sorting compartments 12 disposed consecutively along a sorting section and thus sorted into delivery sequence order for a mail carrier or parcel deliverer in a two-stage process.

In a first sorting cycle, the sortation items 2 are sorted according to destinations positions A to E, the sortation items 2 having already been pre-sorted to the extent that only the sortation items 2 intended for that delivery route W are fed into the sorting conveyor 16. Incorrectly pre-sorted sortation items 2 are suitably extracted, whether by one of the feeding stations 8,9 or after a sorting attempt has been performed. The sortation items 2 are then removed from the sorting compartments 12 and returned to the feeding stations 8,9. The sortation items 2 of the sorting compartments 12 of the first and second destination route section W1,W2 may be combined in each case and transferred to the feeding station 8 or 9. The feeding stations 8 or 9 are disposed upstream of the relevant destination route section W1 and W2.

In a second sorting cycle, the item are sorted according to their destinations within sub-sections I-VI. The sortation items 2 are removed from the sorting compartments 14 and are now sorted according to the destination positions A to E of their specified delivery route W.

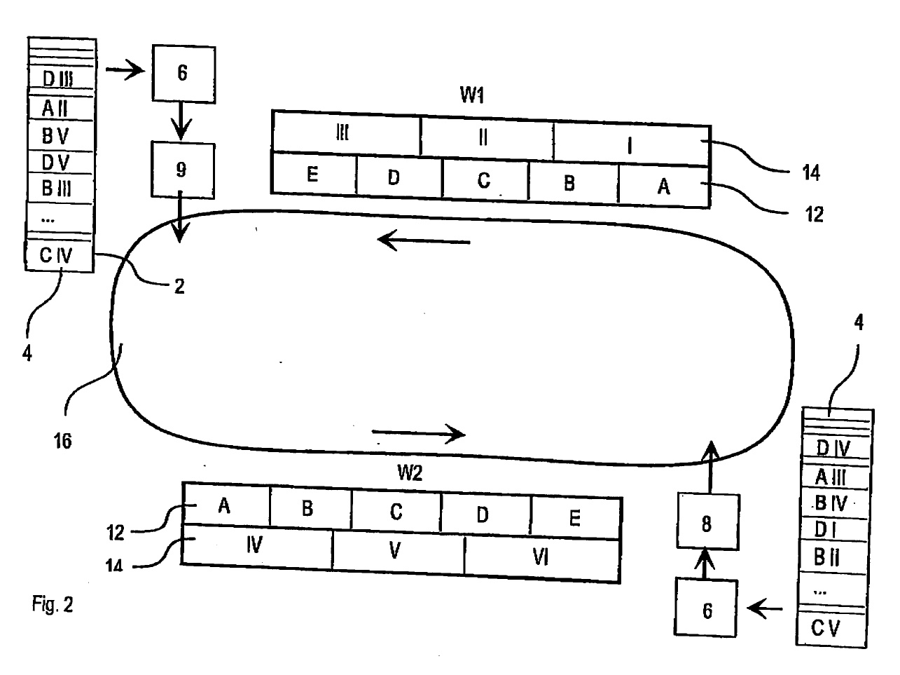

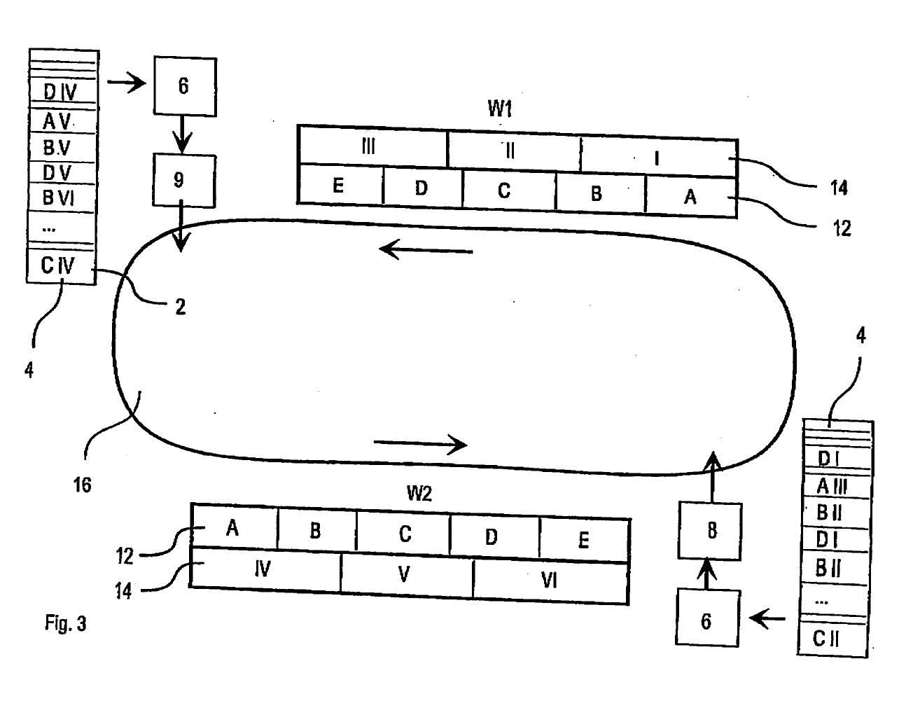

FIGS. 2 and 3 show two variants of the method according to the invention using the example of a continuous sorting conveyor 16 with two feeding stations 8 and 9. The destination route W is subdivided into two destination route sections W1 and W2. Between the two feeding stations 8 and 9 there are disposed sorting compartments 12 representing the destination route sections W1 and W2.

In the variant shown in FIG. 2, the sortation items 2 for the entire destination route W, are fed into the continuous sorting conveyor 16 at the first and second feeding stations 8 and 9.

In a first sorting cycle, the sortation items 2 are conveyed to the sorting compartments 12 according to their destination position A to B and their destination route section W1 and W2 irrespective of the destination sub-section I-VI. As depicted, the number of sorting compartments 12 corresponds to the maximum number of destination positions A to B within the destination sub-sections I to III and IV to VI of destination route sections W1 and W2 respectively. The first sorting compartment forms the first position for destination sub-sections I to III of the destination route section W1. The sortation items in each of the sub-sections are fed out sequentially for sorting into the relevant destination sub-section I, II or III.

In the variant of the method according to the invention shown in FIG. 2, the sortation items 2 are not only transferred from the first feeding station 8 to the sorting compartments 12 of the first destination route section W1, but also to the sorting compartments 12 of the second destination route section W2. This means that only some of the receiving elements of the continuous sorting conveyor 16 are available for receiving new sortation items 2 from the second feeding station 9. Receiving elements supplied from the feeding station 8 which have also received sortation items 2 for the destination route section W2 are therefore still occupied for receiving sortation items 2 at the second feeding station 9. The converse also applies to the second feeding section 9.

In a second sorting cycle of the variant shown in FIG. 2, the sortation items 2 of the first destination route section W1 and the sortation items 2 of the second destination route section W2 are combined and conveyed to the feeding station 8 or 9 preceding the relevant destination route section W1 and W2. The sortation items 2 conveyed to the sorting compartments 12 in the first sorting cycle can be returned to the continuous sorting conveyor 16, now in the sequence of the destination positions A to E. A number of sorting compartments 14 corresponding to the number of destination sub-sections I to VI is required. The sortation items 2 are now sorted according to their relevant destination sub-section I to VI and according to the destination route section W1 and W2 and are now available sorted in delivery route order for the mail carrier.

In contrast to FIG. 2, in the variant shown in FIG. 3, the sortation items 2 are fed in pre-sorted to the extent that sortation items 2 for the first destination route section W1 are fed in only by the first feeding station 8 and the sortation items 2 for the second destination route section W2 are fed in only by the second feeding station 9.

The basic sequence of sortation in two sorting cycles corresponds to the sorting method described above with reference to FIG. 1.

In the variant shown in FIG. 3, all the sortation items 2 which are transferred from the first feeding station 8 to the continuous sorting conveyor 16 are transferred to the sorting compartments 12 of the first destination route section W1 and all the sortation items 2 which are transferred from the second feeding station 9 to the continuous sorting conveyor 16 are transferred to the sorting compartments 12 of the second destination route section W2.

All the sortation items 2 transferred from the first feeding station 8 to the continuous sorting conveyor 16 have therefore been transferred to the sorting compartments after passing the sorting compartments for the destination path section W1. The receiving elements for accommodating the sortation items 2 are now free to receive the sortation items 2 of the second feeding station 9. Pre-sorting of the sortation items 2 according to the destination route sections W1 and W2 is required for this variant of the method according to the invention, which can, however, be performed as early as the sorting of the sortation items 2 to a defined delivery route W.

With this variant, the sorting capacity of the sorting facility is comparatively optimally utilized. In the variant shown in FIG. 2, it is possible to employ a smaller sorting depth than in this variant, i.e. the sortation items 2 need only to be pre-sorted for the destination route W and not for the individual destination route sections W1 and W2.

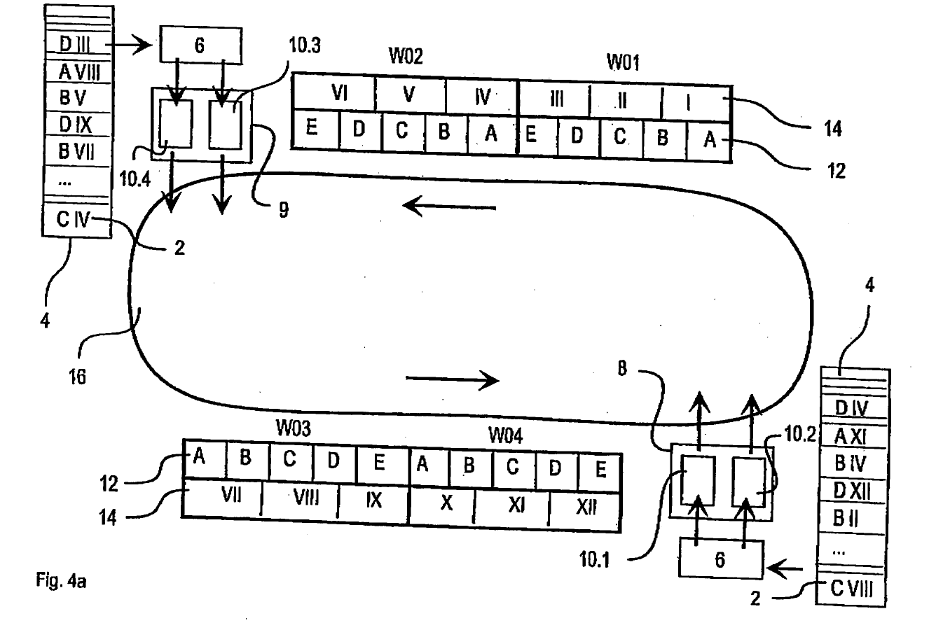

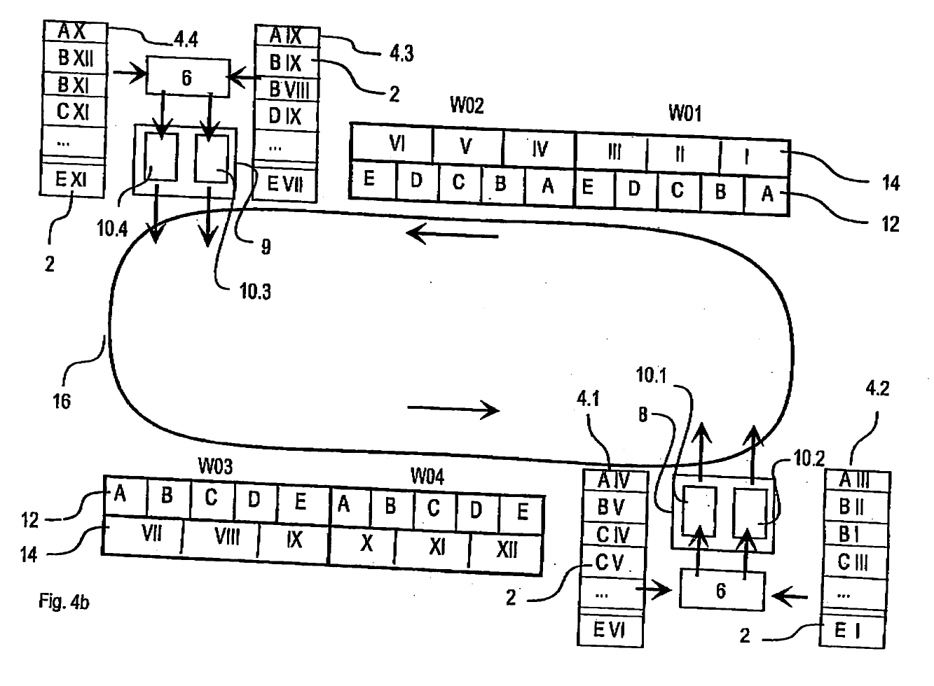

The feeding capacity of a feeding stations 8 and 9 is limited. As depicted in FIGS. 4a and 4b, the feeding capacity of a feeding station 8 and 9 and therefore the sorting capacity of the sorting facility, can be increased by using a plurality of feeding conveyors 10.1,10.2 and 10.3,10.4 at a feeding station 8 and 9 respectively. However, the feeding of sortation items 2, by e.g. two feeding conveyors 10.1,10.2 and 10.3,10.4, of a feeding station 8 and 9 respectively, from a common sortation stack 4, for a second sorting cycle, can result in a changing of the sequence of the destination positions A to E in the first sorting cycle. For example, the upstream feeding conveyor 10.1 of the two feeding conveyors 10.1 and 10.2, in the conveying direction of the sorting conveyor 16, conveys another sortation item 2 with the destination position A, while the second feeding conveyor 10.2 is already conveying a sortation item 2 of destination position B. The sortation item 2 of destination position B gets ahead of the sortation item 2 of destination position A. The sequence of the sortation items 2 according to their destination position A to E is therefore changed. With a combination of the variant of the method according to the invention as shown in FIG. 2 for a first sorting cycle and the variant of the method according to the invention as shown in FIG. 3 for a second sorting cycle, this problem is solved and the capacity of the sorting facility is even more optimally utilized by increasing the feeding capacity of the feeding stations 8 and 9.

A combination of the variants shown in FIGS. 2 and 3 is illustrated in FIGS. 4a and 4b. FIGS. 4a and 4b show an exemplary embodiment of the method according to the invention of the continuous sorting conveyor 16 with two feeding stations 8,9 each having two feeding conveyors 10.1,10.2 and 10.3,10.4 respectively, wherein a destination route W0 is subdivided into four destination route sections W01,W02,W03, and W04. Although the number of destination route sections W01,W02,W03, and W04 is double the number of feeding stations 8 and 9, the number of destination route sections correspond to the number of feeding conveyors 10.1,10.2,10.3,10.4.

FIG. 4a schematically illustrates a first sorting cycle and FIG. 4b a second sorting cycle. Each feeding conveyor 10.1,10.2,10.3, and 10.4 is assigned a destination route section W01,W02,W03, and W04.

As shown in FIG. 4a for the first sorting cycle, the sortation items 2 are fed into the continuous sorting conveyor 16 for the entire destination route W0 from both feeding stations 8 and 9 and therefore from the four feeding conveyors 10.1,10.2,10.3 and 10.4 and conveyed to a corresponding sorting compartment 12 according to their destination position A to E and their destination route section W01,W02,W03,W04 irrespective of the destination sub-section I to XII. The number of sorting compartments 12 corresponds at least to the maximum number of destination positions A to E within the destination sub-sections I to XII of a destination route section W01,W02,W03, and W04.

On completion of the first sorting cycle, the sortation items 2 of the relevant destination route sections W01,W02,W03,W04 thus conveyed to the sorting compartments 12 in the sequence of the destination positions A to E are combined and transferred to the corresponding feeding conveyor 10.1,10.2,10.3,10.4. For the second sorting cycle, the sortation items 2 are fed back into the continuous sorting conveyor 16 from the relevant sortation stack 4.1,4.2,4.3, and 4.4. The sortation items 2 are sorted into a number of sorting compartments 14 corresponding to the number of destination sub-sections I to XII according to their relevant destination sub-section I to XII, the corresponding destination route section W01 to W04 having already been determined by the corresponding sortation in the first sorting cycle. A schematic illustration of this second sorting cycles is shown in FIG. 4b.

In order to utilize the capacity of the sorting compartments 12,14 as evenly as possible, the destination sub-section X, for example, has only two destination positions A and B, e.g. two adjacent multiple dwellings. Accordingly, the destination positions A to E of the destination sub-section XI can be five multiple dwellings along the delivery route W. This sub-division is based on the experience that, purely statistically, approximately equal volumes of mail are produced in each destination sub-section with this apportionment. The subdivision into destination route sections W01 to W04 is performed on approximately the same empirical basis, so that the capacity of the sorting conveyor 16 is utilized as evenly as possible in terms of the volume of mail along the sorting path.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

We claim:

1. A method for sorting delivery-information-bearing sortation items, using a continuous sorting conveyor, according to a specifiable destination route, with a number of destination route sections each subdivided into a number of destination sub-sections, the destination sub-sections having a number of consecutive destination positions, comprising the steps of:
feeding the sortation items, in a first pass, to the continuous sorting conveyor using at least two feeding stations, said at least two feeding stations corresponding to no more than a number of destination route sections and having a number of sorting compartments disposed between two feeding stations;
conveying, in a first sorting cycle, said sortation items according to their relevant destination position to a corresponding sorting compartment, the number of consecutive sorting compartments corresponding to the largest number of destination positions located within one of the destination sub-sections; and
feeding said sortation items conveyed to said sorting compartments back to said sorting conveyor by said feeding stations, said feeding said sortation items being performed in a sequence of said destination positions and said sortation items conveyed according to their relevant destination sub-section to a sorting compartment corresponding to said destination sub-section as well as a number of sorting compartments corresponding to a number of destination sub-sections.

2. The m thod according to claim 1, wherein, prior to said first pass, said sortation items are pre-sorted according to destination route sections and fed by said feeding stations in a preceding one of said sorting compartments associated said destination route sections.

3. The method according to claim 2, wherein said number of sorting compartments required for sorting for a destination route section is disposed between two feeding stations.

4. The method according to claim 1, wherein the destination route sections are dimensioned such that an approximately even number of sortation items is sorted to each destination route section.

5. The method according to claim 2, wherein the destination route sections are dimensioned such that an approximately even number of sortation items is sorted to each destination route section.

6. The method according to claim 3, wherein the destination route sections are dimensioned such that an approximately even number of sortation items is sorted to each destination route section.

7. The method according to claim 1, wherein the number of destination positions and destination sub-sections within the destination route sections are approximately the same.

8. The method according to claim 2, wherein the number of destination positions and destination sub-sections within the destination route sections are approximately the same.

9. The method according to claim 3, wherein the number of destination positions and destination sub-sections within the destination route sections are approximately the same.

10. The method according to claim 4, wherein the number of destination positions and destination sub-sections within the destination route sections are approximately the same.

11. The method according to claim 5, wherein the number of destination positions and destination sub-sections within the destination route sections are approximately the same.

12. The method according to claim 6, wherein the number of destination positions and destination sub-sections within the destination route sections are approximately the same.

13. The method according to claim 1, wherein between two feeding stations there are disposed at least two sorting compartments corresponding to destination route sections and a number of feeding conveyors corresponding to said destination route sections, of which there are at least two, are disposed in the upstream feeding station.

14. The method according to claim 2, wherein between two feeding stations there are disposed at least two sorting compartments corresponding to destination route sections and a number of feeding conveyors corresponding to said destination route sections, of which there are at least two, are disposed in the upstream feeding station.

15. The method according to claim 3, wherein between two feeding stations there are disposed at least two sorting compartments corresponding to destination route sections and a number of feeding conveyors corresponding to said destination route sections, of which there are at least two, are disposed in the upstream feeding station.

16. The method according to claim 4, wherein between two feeding stations there are disposed at least two sorting compartments corresponding to destination route sections and a number of feeding conveyors corresponding to said destination route sections, of which there are at least two, are disposed in the upstream feeding station.

17. The method according to claim 7, wherein between two feeding stations there are disposed at least two sorting compartments corresponding to destination route sections and a number of feeding conveyors corresponding to said destination route sections, of which there are at least two, are disposed in the upstream feeding station.

18. The method according to claim 13, wherein only sortation items are pre-sorted for one of the route sections and fed to each feeding conveyor.

19. The method according to claim 14, wherein only sortation items are pre-sorted for one of the route sections and fed to each feeding conveyor.

20. The method according to claim 15, wherein only sortation items are pre-sorted for one of the route sections and fed to each feeding conveyor.

21. The method according to claim 16, wherein only sortation items are pre-sorted for one of the route sections and fed to each feeding conveyor.

22. The method according to claim 17, wherein only sortation items are pre-sorted for one of the route sections and fed to each feeding conveyor.
